(19) United States
(12) Patent Application Publication
(10) Pub. No.: US 2018/0068164 A1
(43) Pub. Date: Mar. 8, 2018

(54) SYSTEMS AND METHODS FOR IDENTIFYING PESTS IN CROP-CONTAINING AREAS VIA UNMANNED VEHICLES

(71) Applicant: Wal-Mart Stores, Inc., Bentonville, AR (US)

(72) Inventors: Robert L. Cantrell, Herndon, VA (US); John P. Thompson, Bentonville, AR (US); David C. Winkle, Bella Vista, AR (US); Michael D. Atchley, Springdale, AR (US); Donald R. High, Noel, MO (US); Todd D. Mattingly, Bentonville, AR (US); Brian G. McHale, Greater Manchester (GB); John J. O'Brien, Farmington, AR (US); John F. Simon, Pembroke Pines, FL (US)

(21) Appl. No.: 15/698,012

(22) Filed: Sep. 7, 2017

Related U.S. Application Data
(60) Provisional application No. 62/384,850, filed on Sep. 8, 2016.

(51) Int. Cl. G06K 9/00; A01M 31/00; B64C 39/02; G06K 9/32; G06Q 50/02

(52) U.S. Cl. CPC G06K 9/0063; A01M 31/002; G06Q 50/02; B64C 39/024; G06K 9/3241; G06K 9/00671

(57) ABSTRACT

In some embodiments, methods and systems of identifying at least one pest in a crop-containing area include an unmanned vehicle including a visible light video camera configured to detect a pest in the crop-containing area and to capture first pest detection data and an infrared video camera configured to detect a pest in the crop-containing area and to capture second pest detection data. A computing device including a processor-based control circuit and configured to communicate with the unmanned vehicle is configured to receive the first pest detection data and the second pest detection data via the network from the UAV, and, in response to receipt of the first and second pest detection data from the UAV, the control circuit of the computing device is configured to combine the first and second pest detection data to create a combined pest detection data, which in turn enables the control circuit of the computing device to determine an identity of the pest based on the pest identity data and the combined pest detection data.

### CROSS-REFERENCE TO RELATED APPLICATION

This application claims the benefit of U.S. Provisional Application No. 62/384,850, filed Sep. 8, 2016, which is incorporated herein by reference in its entirety.

### TECHNICAL FIELD

This disclosure relates generally to identifying pests in a crop-containing area, and in particular, to identifying pests in a crop-containing area via unmanned vehicles.

### BACKGROUND

Monitoring crops and defending crops against crop-damaging pests is paramount to farmers. Methods of protecting crops from crop-damaging pests include scarecrows or other devices mounted in the crop-containing areas that are designed to generically scare away all pests. Scarecrows or reflective tape/foil mounted on or near crops may be able to scare away some pests (e.g., birds), but usually do not have any effect on other pests (e.g., insects), and do not enable the farmers to identify the pest or pests attacking the crops in the crop-containing area. Methods of protecting crops from crop-damaging pests also include chemical spraying designed to drive away and/or kill crop-attacking pests. Chemical sprays typically target one type of pest while not affecting other types of pests. Given that the above anti-pest devices repel, but do not identify the crop-attacking pests, selecting an appropriate chemical anti-pest treatment for the crops can be difficult for the farmers, often forcing the farmers to use multiple chemical sprays as a prophylactic against multiple pests that may attack the crops in the crop-containing area. However, chemical spraying of crops is expensive and may not be looked upon favorably by some consumers.

### BRIEF DESCRIPTION OF THE DRAWINGS

Disclosed herein are embodiments of systems, devices, and methods pertaining to identifying one or more pests in a crop-containing area. This description includes drawings, wherein:

FIG. 1 is a diagram of a system for identifying at least one pest in a crop-containing area in accordance with some embodiments;

FIG. 2 comprises a block diagram of a UAV as configured in accordance with various embodiments of these teachings;

FIG. 3 is a functional block diagram of a computing device in accordance with some embodiments; and

FIG. 4 is a flow diagram of a method of identifying at least one pest in a crop-containing area in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally, the systems, devices, and methods described herein provide for identifying pests in a crop-containing area against crop-damaging pests via one or more UAVs configured to capture pest detection data in a crop-containing area and identifying one or more pests based on the captured pest detection data.

In one embodiment, a system for identifying at least one pest in a crop-containing area includes: at least one unmanned aerial vehicle including a visible light video camera configured to detect at least one pest in the crop-containing area and to capture first pest detection data and an infrared video camera configured to detect at least one pest in the crop-containing area and to capture second pest detection data; at least one electronic database including pest identity data associated with the at least one pest; and a computing device including a processor-based control circuit and configured to communicate with the at least one unmanned aerial vehicle and the at least one electronic database via a network. The at least one unmanned aerial vehicle is configured to transmit the first pest detection data and the second pest detection data via the network to the computing device. In response to receipt of the first and second pest detection data via the network from the at least one unmanned aerial vehicle, the control circuit of the computing device is configured to combine the first and second pest detection data to create a combined pest detection data, and the control circuit of the computing device is configured to determine an identity of the at least one pest based on the pest identity data and the combined pest detection data.

In another embodiment, a method of identifying at least one pest in a crop-containing area includes: providing at least one unmanned aerial vehicle including a visible light video camera and an infrared video camera; detecting at least one pest in the crop-containing area and capturing first pest detection data via the visible light video camera; detecting the at least one pest in the crop-containing area and capturing second pest detection data via the infrared video camera; providing at least one electronic database including pest identity data associated with the at least one pest; providing a computing device including a processor-based control circuit and configured to communicate with the at least one unmanned aerial vehicle and the at least one electronic database via a network; transmitting the first pest detection data and the second pest detection from the at least one unmanned aerial vehicle over the network to the computing device; receiving the first and second pest detection data via the network from the at least one unmanned aerial vehicle at the computing device; combining the first and second pest detection data via the control circuit of the computing device to create a combined pest detection data; and determining, via the control circuit of the computing device, an identity of the at least one pest based on the pest identity data and the combined pest detection data.

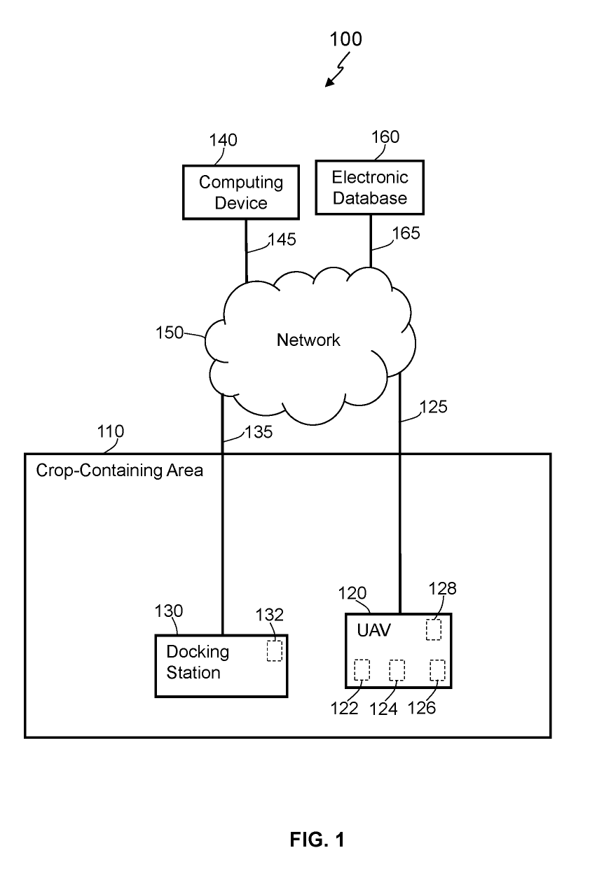

FIG. 1 illustrates an embodiment of a system 100 for identifying at least one pest in a crop-containing area 110. It will be understood that the details of this example are intended to serve in an illustrative capacity and are not necessarily intended to suggest any limitations in regards to the present teachings.

Generally, the exemplary system 100 of FIG. 1 includes a UAV 120 including one or more components configured to detect, and facilitate the identification of, one or more pests in the crop-containing area 110. In some embodiments, the UAV 120 includes output components configured to eliminate pests from the crop-containing area 110. Examples of some suitable output devices are discussed in co-pending application entitled “SYSTEMS AND METHODS FOR DEFENDING CROPS FROM CROP-DAMAGING PESTS VIA UNMANNED VEHICLES,” filed Sep. 8, 2016, which is incorporated by reference herein in its entirety.

While only one UAV 120 is shown in FIG. 1, it will be appreciated that the system 100 may include two or more UAVs 120 configured to patrol the crop-containing area 110 and detect a pest or pests in the crop-containing area 110. The system 100 also includes a docking station 130 configured to permit the UAV 120 to land thereon, dock thereto, and recharge. While only one docking station 130 is shown in FIG. 1, it will be appreciated that the system 100 may include two or more docking stations 130. While the docking station 130 is shown in FIG. 1 as being located in the crop-containing area 110, it will be appreciated that one or more (or all) docking stations 130 may be positioned outside of the crop-containing area 110. The docking station 130 may be configured as an immobile or mobile station. Generally, the UAV 120 is configured to fly above ground through a space overlying the crop-containing area 110 and to land and dock onto a docking station 130 (e.g., for recharging), as described in more detail below. The exemplary system 100 also includes a processor-based computing device 140 in two-way communication with the UAV 120 (e.g., via communication channels 125 and 145) and/or docking station 130 (e.g., via communication channels 135 and 145) over the network 150, and an electronic database 160 in two-way communication with at least the computing device 140 (e.g., via communication channels 145 and 165) over the network 150.

The network 150 may be one or more wireless networks of one or more wireless network types (such as, a wireless local area network (WLAN), a wireless personal area network (PAN), a wireless mesh network, a wireless star network, a wireless wide area network (WAN), a local area network (LAN), a cellular network, and combinations of such networks, and so on), capable of providing wireless coverage of the desired range of the UAV 120 according to any known wireless protocols, including but not limited to a cellular, Wi-Fi or Bluetooth network. In the system 100 of FIG. 1, the computing device 140 is configured to access at least one electronic database 160 via the network 150, but it will be appreciated that the computing device 140 may be configured such that the computing device 140 is directly coupled to the electronic database 160 and can access information stored in the electronic database 160 directly, not via the network 150.

It will be appreciated that more or fewer of such components may be included in different embodiments of the system 100. For example, in some embodiments, the docking station 130 is optional to the system 100 and, in such embodiments, the UAV 120 is configured to take off from a deployment station (e.g., stand-alone or vehicle mounted) to initiate patrolling of the crop-containing area 110, and to return to the deployment station without recharging after patrolling the crop-containing area 110. In addition, in some aspects, the computing device 140 and the electronic database 160 may be implemented as separate physical devices as shown in FIG. 1 (which may be at one physical location or two separate physical locations), or may be implemented as a single device. In some embodiments, the electronic database 160 may be stored, for example, on non-volatile storage media (e.g., a hard drive, flash drive, or removable optical disk) internal or external to the computing device 140, or internal or external to computing devices distinct from the computing device 140. In some embodiments, the electronic database 160 is cloud-based.

In some embodiments, the UAV 120 deployed in the exemplary system 100 does not require physical operation by a human operator and wirelessly communicates with, and is wholly or largely controlled by, the computing device 140. In particular, in some embodiments, the computing device 140 is configured to control directional movement and actions (e.g., flying, hovering, landing, taking off, moving while on the ground, generating sounds that scare away or herd pests, etc.) of the UAV 120 based on a variety of inputs.

Generally, the UAV 120 of FIG. 1 is configured to move around the crop-containing area and detect one or more pests in the crop-containing area 110. While an unmanned aerial vehicle is generally described herein, in some embodiments, an aerial vehicle remotely controlled by a human may be utilized with the systems and methods described herein without departing from the spirit of the present disclosure. In some embodiments, the UAV 120 may be in the form of a multicopter, for example, a quadcopter, hexacopter, octocopter, or the like. In one aspect, the UAV 120 is an unmanned ground vehicle (UGV) that moves on the ground around the crop-containing area 110 under the guidance of the computing device 140 (or a human operator). In some embodiments, as described in more detail below, the UAV 120 includes a communication device (e.g., transceiver) configured to communicate with the computing device 140 while the UAV 120 is in flight and/or when the UAV 120 is docked at a docking station 130.

The exemplary UAV 120 shown in FIG. 1 includes sensors 122, a visible light video camera 124, an infrared video camera 126, and a microphone 128. Generally, the sensors 122, visible light video camera 124, infrared video camera 126, and microphone 128 facilitate the monitoring of the crop-containing area 110, detection of the presence of one or more pests (e.g., insect, bird, or animal) in the crop-containing area 110, and capture of pest detection data, which is then analyzed by the computing device 140 to identify such pests as will be described in more detail below. While the microphone 128 is illustrated in FIG. 1 as a device that is separate from the visible light video camera 124 and the infrared video camera 126, it will be appreciated that in some aspects, each of the visible light video camera 124 and infrared video camera 126 can include a built in microphone.

In some embodiments, the sensor 122 of the UAV 120 of FIG. 1 is a radar-enabled sensor configured to detect movement of one or more pests outside of the crop-containing area 110, for example, as the pests are approaching the crop-containing area 110, by air, ground, or sea. In one aspect, the sensor 122 is a motion detection-enabled sensor configured to detect movement of one or more pests in the crop-containing area 110. In some embodiments, the sensor 122 is configured to activate one or both of the visible light video camera 124 and the infrared video camera 126 in response to the detection of movement, by the motion sensor, of one or more pests in, or adjacent to, the crop-containing area 110.

In some embodiments, the sensor 122 may be configured to detect one or more odors emitted by pests in the crop-containing area 110. Such odors may include odors emitted by the pests themselves and/or odors emanating from pest droppings in the crop-containing area.

In some embodiments, one or more sensors 122 of the UAV 120 are configured to detect the presence of at least one type of non-pest crop-damaging factor in the crop-containing area 110 and to capture the characteristics of the presence of such a non-pest crop-damaging factor, which is then analyzed by the computing device 140 to identify the environmental factor responsible for the crop damage, and to determine a set of instructions for the UAV 120 to remedy such a crop-damaging environmental factor. For example, in one aspect, the non-pest damage to one or more crops detectable by the sensor 122 of the UAV 120 in the crop-containing area 110 includes environmental damage including, but not limited to: fungus presence on leaves, fruits, flowers, or stalks of the crops, presence of dark, rotting spots on the fruits growing on the crops (which may be caused by bacteria, mold, mildew, etc.), unbalanced soil content (e.g., indicated by yellowing or dwarfed leaves, etc.), soil damage and/or erosion causes by rain, drought, wind, frostbite, earthquake, over-fertilization, animals (e.g., deer, gophers, moles, grub worms, etc.), and/or other plants or trees (e.g., crop-damaging plants or weeds such as Kudzu, or poisonous plants such as poison ivy). In some embodiments, after receiving data indicating detection of crop damage attributable to one or more such environmental factors from the UAV 120, the computing device 140 instructs the UAV 120 to deploy one or more remedial measures.

For example, in one aspect, if flood damage to crops and/or crop-containing soil is detected by the sensor 122 of the UAV 120 in one corner of the crop-containing area 110, the computing device 140 instructs the UAV 120 to deploy one or more sand bags to the flood-affected area. In another aspect, if soil damage consistent with digging/burrowing insect or mammal pests is detected by the sensor 122 of the UAV 120, the computing device 140 instructs the UAV 120 to deploy one or more predators (e.g., birds such as purple martins, owls, etc., bats, insects such as praying mantis, or certain species of snakes) that would be expected to exterminate and/or scare away the soil damage-causing pests from the affected area. In one aspect, for certain types of detected non-pest crop damage, the computing device 140 instructs the UAV 120 to deploy one or more insects beneficial to crops (e.g., lady bus, bees, etc.) in the affected area in order to improve the health and/or productivity of the crops.

In some embodiments, as described in more detail below, the sensors 122 of the UAV 120 include one or more docking station-associated sensors including but not limited to: an optical sensor, a camera, an RFID scanner, a short range radio frequency transceiver, etc. Generally, the docking station-associated sensors of the UAV 120 are configured to detect and/or identify the docking station 130 based on guidance systems and/or identifiers of the docking station 130. For example, the docking station-associated sensor of the UAV 120 may be configured to capture identifying information of the docking station from one or more of a visual identifier, an optically readable code, a radio frequency identification (RFID) tag, an optical beacon, and a radio frequency beacon.

The visible light video camera 124 of the UAV 120 of FIG. 1 is configured to detect one or more pest in the crop-containing area 110 and to capture first pest detection data. The visible light video camera 124 is configured to capture visible frequency video data of pests in the crop-containing area 110, and may be motion-activated video camera and/or a high definition video camera. The first pest detection data captured by the visible light video camera 124 may include but is not limited to a real-time video or digital still image of the pest in the crop-containing area 110, a real time video or digital still image of pest droppings, nests, and/or carcasses in the crop-containing area 110, or the like).

The infrared video camera 126 of the UAV 120 of FIG. 1 is configured to detect the presence of one or more pest in the crop-containing area 110 and to capture second pest detection data. The infrared video camera 126 is configured to capture infrared frequency video data of pests in the crop-containing area 110, and may be a motion-activated video camera and/or a high definition video camera. In one aspect, the infrared video camera 126 operates by capturing infrared frequency-based pest detection data at night, when no little or no visible light is present. The first pest detection data captured by the infrared video camera 126 may include but is not limited to an infrared real-time video or digital still image of the pest in the crop-containing area 110, an infrared real time video or digital still image of pest droppings, nests, and/or carcasses in the crop-containing area 110, or the like). In some aspects the infrared video camera 126 is configured for thermal detection of pest heat signatures in the crop-containing area 110.

Generally, one difference between visible light sensors and infrared sensors is that visible light has ability to represent the background in a sharper and clearer way than infrared light. Without wishing to be limited by theory, one reason for this difference is that visible light cameras are generally not used to measure temperature and generate visible light images by recording reflected visible light, which usually produces sharper images than infrared cameras that are used to measure temperature and record emitted infrared radiation. For example, reflected visible radiation can produce sharp contrast with sharp edges and intensity differences, as would be visible, for example, when a thin, light-colored line appears next to a thin, dark-colored line. Conversely, when using infrared cameras, it is generally not common to have surfaces with sharp temperature differences next to each other, since heat transfer between nearby or adjacent objects can wash out temperature differences by producing temperature gradients that make it difficult to produce images of emitted radiation with sharp edges.

As will be discussed in more detail below, in some embodiments, after detection, by the visible light video camera 124 and the infrared video camera 126, of one or more pests in the crop-containing area 110, the UAV 120 is configured to send a signal to the computing device 140 (via the network 150) including the first pest detection data captured by the visible light video camera 124 and the second pest detection data captured by the infrared video camera 126, and in response to receipt of such a signal from the UAV 120, the computing device 140 is configured to combine the first and second pest detection data to create a combined pest detection data. Since the combined pest detection data includes both reflected visible light data and emitted infrared radiation data, the combined pest detection data is sharp, clear, and includes temperature information of the object (i.e., pest and/or pest background (e.g., leaf, stalk, soil, etc.) environment), thereby facilitating a more accurate detection and/or identification of pests in the crop-containing area 110 during daylight hours and at night by the computing device 140.

In some embodiments, the microphone 128 of the UAV 120 of FIG. 1 is configured to detect sounds made by one or more pests in the crop-containing area 110. The microphone 128 may be configured to pick up a wide variety of sound frequencies associated with sounds emitted by pests known to attack crops in the crop-containing area 110.

As discussed above, while only one UAV 120 is shown in FIG. 1 for ease of illustration, it will be appreciated that in some embodiments, the computing device 140 may communicate with and/or provide flight route instructions and/or pest identifying information to two or more UAVs 120 simultaneously to guide the UAVs 120 along their predetermined routes while patrolling the crop-containing area 110 against undesired pests. In some embodiments, the sensors 122 of the UAV 120 may include other flight sensors such as optical sensors and radars for detecting obstacles (e.g., other UAVs 120) to avoid collisions with such obstacles.

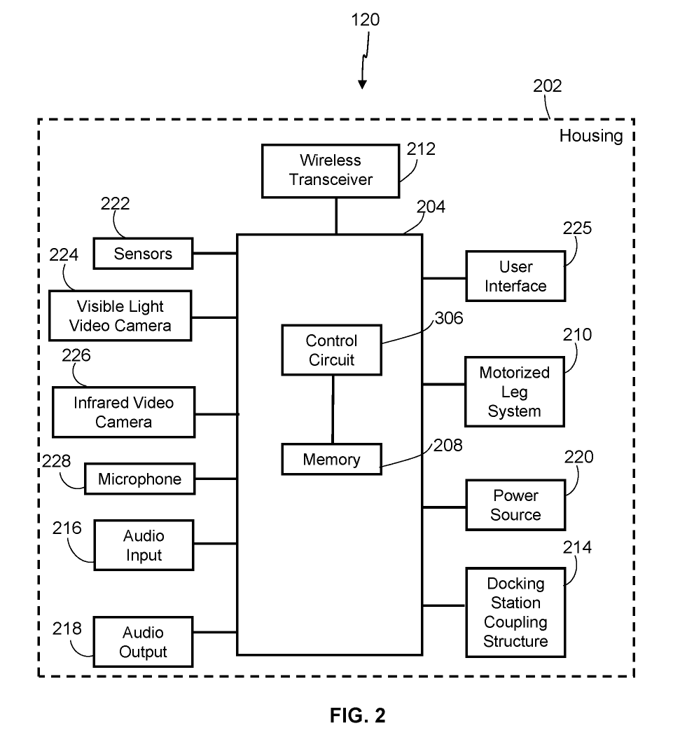

FIG. 2 presents a more detailed example of the structure of the UAV 120 of FIG. 1 according to some embodiments. The exemplary UAV 120 of FIG. 2 has a housing 202 that contains (partially or fully) or at least supports and carries a number of components. These components include a control unit 204 comprising a control circuit 206 that, like the control circuit 310 of the computing device 140, controls the general operations of the UAV 120. The control unit 204 includes a memory 208 coupled to the control circuit 206 for storing data (e.g., pest detection data, operating instructions sent by the computing device 140, or the like).

In some embodiments, the control circuit 206 of the UAV 120 operably couples to a motorized leg system 210. This motorized leg system 210 functions as a locomotion system to permit the UAV 120 to land onto the docking station 130 and/or move while on the docking station 130. Various examples of motorized leg systems are known in the art. Further elaboration in these regards is not provided here for the sake of brevity save to note that the aforementioned control circuit 206 may be configured to control the various operating states of the motorized leg system 210 to thereby control when and how the motorized leg system 210 operates.

In the exemplary embodiment of FIG. 2, the control circuit 206 operably couples to at least one wireless transceiver 212 that operates according to any known wireless protocol. This wireless transceiver 212 can comprise, for example, a cellular-compatible, Wi-Fi-compatible, and/or Bluetooth-compatible transceiver that can wirelessly communicate with the computing device 140 via the network 150. So configured, the control circuit 206 of the UAV 120 can provide information to the computing device 140 (via the network 150) and can receive information and/or movement and/or pest identification information and/or anti-pest output instructions from the computing device 140. For example, the wireless transceiver 212 may be caused (e.g., by the control circuit 206) to transmit to the computing device 140, via the network 150, at least one signal including both the first pest detection data detected by the visible light video camera 124 and second pest detection data detected by the infrared video camera 126 while patrolling the crop-containing area 110. In one aspect, the wireless transceiver 212 may be caused (e.g., by the control circuit 206) to transmit an alert to the computing device 140, or to another computing device (e.g., hand-held device of a worker at the crop-containing area 110) indicating that one or more pests have been detected in the crop-containing area 110. These teachings will accommodate using any of a wide variety of wireless technologies as desired and/or as may be appropriate in a given application setting. These teachings will also accommodate employing two or more different wireless transceivers 212, if desired.

The control circuit 206 also couples to one or more on-board sensors 222 of the UAV 120. These teachings will accommodate a wide variety of sensor technologies and form factors. In one aspect, the on-board sensors 222 are configured to detect the presence of at least one pest in the crop-containing area 110 based on an odor emitted by a pest in the crop-containing area 110. Such sensors 222 can provide information (e.g., pest odor detection data) that the control circuit 206 and/or the computing device 140 can analyze to identify the pest detected by the sensors 222. In some embodiments, the sensors 222 of the UAV 120 are configured to detect objects and/or obstacles (e.g., the presence and/or location of docking station 130, other UAVs 120, birds, etc.) along the path of travel of the UAV 120. In some embodiments, using on-board sensors 222 (such as distance measurement units, e.g., laser or other optical-based distance measurement sensors), the UAV 120 may attempt to avoid obstacles, and if unable to avoid, the UAV 120 will stop until the obstacle is clear and/or notify the computing device 140 of such a condition.

The control circuit 206 also couples to the visible light video camera 224, infrared video camera 226, and microphone 228. As discussed above, the microphone 228 is configured to detect one or more pests in the crop-containing area 110 based on detecting a sound emitted by a pest in the crop-containing area 110, while the visible light video camera 224 and the infrared video camera 226 are configured to detect movement or physical presence of a pest, pest droppings, pests carcasses, and/or pest nests in the crop-containing area 110. As will be discussed in more detail below, the visible light video camera 224 and infrared video camera 226 generate information (e.g., first pest detection data and second pest detection data) that the control circuit 206 of the UAV 120 and/or the control circuit 310 of the computing device 140 can analyze to identify the pest detected by the visible light video camera 224 and the infrared video camera 226. In addition, the microphone 228 of the UAV 120 may capture a sound emitted by a pest in the crop-containing area 110 that enables identification of the pest by the computing device 140.

By one optional approach, an audio input 216 (such as a microphone) and/or an audio output 218 (such as a speaker) can also operably couple to the control circuit 206 of the UAV 120. So configured, the control circuit 206 can provide for a variety of audible sounds to enable the UAV 120 to communicate with the docking station 130 or other UAVs 120. Such sounds can include any of a variety of tones and other non-verbal sounds.

In the embodiment of FIG. 2, the UAV 120 includes a rechargeable power source 220 such as one or more batteries. The power provided by the rechargeable power source 220 can be made available to whichever components of the UAV 120 require electrical energy. By one approach, the UAV 120 includes a plug or other electrically conductive interface that the control circuit 206 can utilize to automatically connect to an external source of electrical energy (e.g., charging dock 132 of the docking station 130) to recharge the rechargeable power source 220. By one approach, the UAV 120 may include one or more solar charging panels to prolong the flight time (or on-the-ground driving time) of the UAV 120.

These teachings will also accommodate optionally selectively and temporarily coupling the UAV 120 to the docking station 130. In such embodiments, the UAV 120 includes a docking station coupling structure 214. In one aspect, a docking station coupling structure 214 operably couples to the control circuit 206 to thereby permit the latter to control movement of the UAV 120 (e.g., via hovering and/or via the motorized leg system 210) towards a particular docking station 130 until the docking station coupling structure 214 can engage the docking station 130 to thereby temporarily physically couple the UAV 120 to the docking station 130. So coupled, the UAV 120 can recharge via a charging dock 132 of the docking station 130.

In some embodiments, the UAV 120 includes an output device that is coupled to the control circuit 206. Such an output device is configured to eliminate one or more pests detected in the crop-containing area 110. As discussed above, examples of some suitable output devices are discussed in co-pending application entitled “SYSTEMS AND METHODS FOR DEFENDING CROPS FROM CROP-DAMAGING PESTS VIA UNMANNED VEHICLES,” filed Sep. 8, 2016, which is incorporated by reference herein in its entirety.

In some embodiments, the UAV 120 includes a user interface 225 including for example, user inputs and/or user outputs or displays depending on the intended interaction with a user (e.g., operator of computing device 140) for purposes of, for example, manual control of the UAV 120, or diagnostics, or maintenance of the UAV 120. Some exemplary user inputs include bur are not limited to input devices such as buttons, knobs, switches, touch sensitive surfaces, display screens, and the like. Example user outputs include lights, display screens, and the like. The user interface 225 may work together with or separate from any user interface implemented at an optional user interface unit (e.g., smart phone or tablet) usable by an operator to remotely access the UAV 120. For example, in some embodiments, the UAV 120 may be controlled by a user in direct proximity to the UAV 120 (e.g., a worker at the crop-containing area 110). This is due to the architecture of some embodiments where the computing device 140 outputs the control signals to the UAV 120. These controls signals can originate at any electronic device in communication with the computing device 140. For example, the movement signals sent to the UAV 120 may be movement instructions determined by the computing device 140 and/or initially transmitted by a device of a user to the computing device 140 and in turn transmitted from the computing device 140 to the UAV 120.

The control unit 204 of the UAV 120 includes a memory 208 coupled to a control circuit 206 and storing data such as operating instructions and/or other data. The control circuit 206 can comprise a fixed-purpose hard-wired platform or can comprise a partially or wholly programmable platform. These architectural options are well known and understood in the art and require no further description. This control circuit 206 is configured (e.g., by using corresponding programming stored in the memory 208 as will be well understood by those skilled in the art) to carry out one or more of the steps, actions, and/or functions described herein. The memory 208 may be integral to the control circuit 206 or can be physically discrete (in whole or in part) from the control circuit 206 as desired. This memory 208 can also be local with respect to the control circuit 206 (where, for example, both share a common circuit board, chassis, power supply, and/or housing) or can be partially or wholly remote with respect to the control circuit 206. This memory 208 can serve, for example, to non-transitorily store the computer instructions that, when executed by the control circuit 206, cause the control circuit 206 to behave as described herein. It is noted that not all components illustrated in FIG. 2 are included in all embodiments of the UAV 120. That is, some components may be optional depending on the implementation.

A docking station 130 of FIG. 1 is generally a device configured to permit at least one or more UAVs 120 to dock thereto. As discussed above, in some aspects, the docking station 130 is an optional component of the system 100 of FIG. 1. The docking station 130 may be configured as an immobile station (i.e., not intended to be movable) or as a mobile station (intended to be movable on its own, e.g., via guidance from the computing device 140, or movable by way of being mounted on or coupled to a moving vehicle), and may be located in the crop-containing area 110, or outside of the crop-containing area 110. For example, in some aspects, the docking station 130 may receive instructions from the computing device 140 over the network 150 to move into a position on a predetermined route of a UAV 120 over the crop-containing area 110.

In one aspect, the docking station 130 includes at least one charging dock 132 that enables at least one UAV 120 to connect thereto and charge. In some embodiments, a UAV 120 may couple to a charging dock 132 of a docking station 130 while being supported by at least one support surface of the docking station 130. In one aspect, a support surface of the docking station 130 may include one or more of a padded layer and a foam layer configured to reduce the force of impact associated with the landing of a UAV 120 onto the support surface of the docking station 130. In some embodiments, a docking station 130 may include lights and/or guidance inputs recognizable by the sensors of the UAV 120 when located in the vicinity of the docking station 130. In some embodiments, the docking station 130 may also include one or more coupling structures configured to permit the UAV 120 to detachably couple to the docking station 130 while being coupled to a charging dock 132 of the docking station 130. The docking station 130 may be powered, for example, via an electrical outlet and/or one or more batteries or solar charging panels.

In some embodiments, the docking station 130 is configured (e.g., by including a wireless transceiver) to send a signal over the network 150 to the computing device 140 to, for example, indicate if one or more charging docks 132 of the docking station 130 are available to accommodate one or more UAVs 120. In one aspect, the docking station 130 is configured to send a signal over the network 150 to the computing device 140 to indicate a number of charging docks 132 on the docking station 130 available for UAVs 120. The control circuit 310 of the computing device 140 is programmed to guide the UAV 120 to a docking station 130 moved into position along the predetermined route of the UAV 120 and having an available charging dock 132.

In some embodiments, a docking station 130 may include lights and/or guidance inputs recognizable by the sensors of the UAV 120 when located in the vicinity of the docking station 130. In some aspects, the docking station 130 and the UAV 120 are configured to communicate with one another via the network 150 (e.g., via their respective wireless transceivers) to facilitate the landing of the UAV 120 onto the docking station 130. In other aspects, the transceiver of the docking station 130 enables the docking station 130 to communicate, via the network 150, with other docking stations 130 positioned at the crop-containing area 110.

In some embodiments, the docking station 130 may also include one or more coupling structures configured to permit the UAV 120 to detachably couple to the docking station 130 while being coupled to a charging dock 132 of the docking station 130. In one aspect, the UAV 120 is configured to transmit signals to and receive signals from the computing device 140 over the network 150 only when docked at the docking station 130. For example, in some embodiments, after the pest detected by the UAV 120 in the crop-containing area 110 is identified by the computing device 140, the UAV 120 is configured to receive a signal from the computing device 140 containing an identification of this pest and/or instructions as to how the UAV 120 is respond to the pest only when the UAV 120 is docked at the docking station 130. In other embodiments, the UAV 120 is configured to communicate with the computing device 140 and receive pest identification data and/or pest response instructions from the computing device 140 over the network 150 while the UAV 120 is not docked at the docking station 130.

In some embodiments, the docking station 130 may be configured to not only recharge the UAV 120, but also to re-equip the UAV 120 and/or to add modular external components to the UAV 120. In some embodiments, the docking station 130 is configured to provide for the addition of new modular components to the UAV 120 to enable the UAV 120 to appropriately respond to the identified pests and/or to better interact with the operating environment where the crop-containing area 110 is located. For example, in some aspects, the docking station 130 is configured to enable the coupling of various types of landing gear to the UAV 120 to optimize the ground interaction of the UAV 120 with the docking station 130 and/or to optimize the ability of the UAV 120 to land on the ground in the crop-containing area 110. In some embodiments, the docking station 130 is configured to enable the coupling of new modular components (e.g., rafts, pontoons, sails, or the like) to the UAV 120 to enable the UAV 120 to land on and/or move on wet surfaces and/or water. In some embodiments, the docking station 130 may be configured to enable modifications of the visual appearance of the UAV 120, for example, via coupling, to the exterior body of the UAV 120, one or more modular components (e.g., wings) designed to, for example, prolong the flight time of the UAV 120. It will be appreciated that the relative sizes and proportions of the docking station 130 and UAV 120 are not drawn to scale.

The computing device 140 of the exemplary system 100 of FIG. 1 may be a stationary or portable electronic device, for example, a desktop computer, a laptop computer, a tablet, a mobile phone, or any other electronic device. In some embodiments, the computing device 140 may comprise a control circuit, a central processing unit, a processor, a microprocessor, and the like, and may be one or more of a server, a computing system including more than one computing device, a retail computer system, a cloud-based computer system, and the like. Generally, the computing device 140 may be any processor-based device configured to communicate with the UAV 120, docking station 130, and electronic database 160 in order to guide the UAV 120 as it patrols the crop-containing area 110 and/or docks to a docking station 130 (e.g., to recharge) and/or deploys from the docking station 130.

The computing device 140 may include a processor configured to execute computer readable instructions stored on a computer readable storage memory. The computing device 140 may generally be configured to cause the UAVs 120 to: travel (e.g., fly, hover, or drive), along a route determined by a control circuit of the computing device 140, around the crop-containing area 110; detect the docking station 130 positioned along the route predetermined by the computing device 140; land on and/or dock to the docking station 130; undock from and/or lift off the docking station 130; detect one or more pests in the crop-containing area 110; and/or generate an output configured to eliminate one or more pests from the crop-containing area 110. In some embodiments, as discussed below, the electronic database 160 includes pest identity data associated with the crop-damaging pests to facilitate identification of such pests by the computing device 140, and the computing device 140 is configured to determine the identity of the pest based on both the pest identity data retrieved from the electronic database 160 and the combined pest detection data generated by the control circuit 310 of the computing device 140.

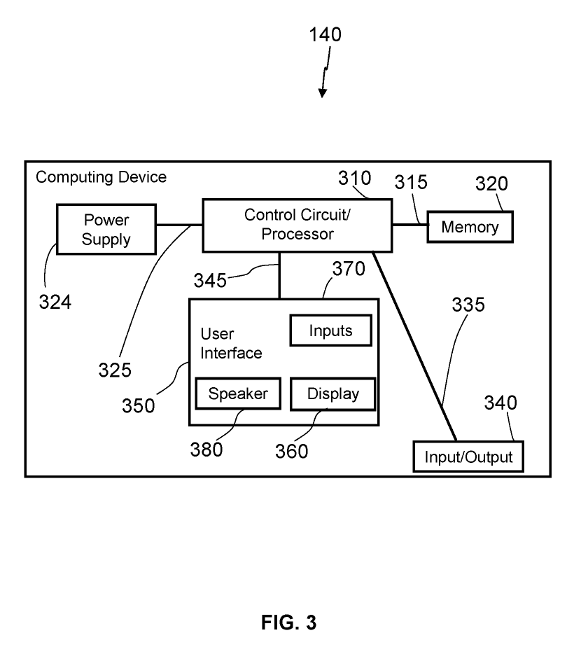

With reference to FIG. 3, a computing device 140 according to some embodiments configured for use with exemplary systems and methods described herein may include a control circuit 310 including a processor (e.g., a microprocessor or a microcontroller) electrically coupled via a connection 315 to a memory 320 and via a connection 325 to a power supply 330. The control circuit 310 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

This control circuit 310 can be configured (for example, by using corresponding programming stored in the memory 320 as will be well understood by those skilled in the art) to carry out one or more of the steps, actions, and/or functions described herein. In some embodiments, the memory 320 may be integral to the processor-based control circuit 310 or can be physically discrete (in whole or in part) from the control circuit 310 and is configured non-transitorily store the computer instructions that, when executed by the control circuit 310, cause the control circuit 310 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control circuit may be referred to as a non-transitory medium or non-transitory computer readable medium.

In some embodiments, the control circuit 310 of the computing device 140 is programmed to, in response to receipt, via the network 150, of the first pest detection data captured by the visible light video camera 124 and the second pest detection data captured by the infrared video camera 126 from the UAV 120, to combine the first and second pest detection data to create a combined pest detection data. In one aspect, the control circuit 310 of the computing device 140 is configured to combine the first and second pest detection data by overlaying the first pest detection data over the second pest detection data to create the combined pest detection data that facilitates a determination, by the control unit 310, of the identity of the pest. In another aspect, the control circuit 310 of the computing device 140 is configured to combine the first and second pest detection data by overlaying the second pest detection data over the first pest detection data to create the combined pest detection data that facilitates a determination, by the control unit 310, of the identity of the pest. As discussed above, since the combined pest detection data includes both reflected visible light data and emitted infrared radiation data, the combined pest detection data advantageously provides a sharp and clear visual representation of a pest in the crop-containing area 110 while including the pest (or pest droppings, carcasses, etc.) temperature information, thereby facilitating a more accurate detection and/or identification of pests in the crop-containing area 110 during daylight hours and at night by the control unit 310.

After the combined pest detection data is generated by the control unit 310, in some embodiments, the control circuit 310 of the computing device 140 is programmed to cause the computing device 140 to transmit the combined pest detection data over the network 150 to the electronic database 160 for storage. As such, electronic database 160 can be updated in real time to include up-to-date information relating to the detection of pests in the crop-containing area 110.

In one aspect, as discussed in more detail below, the control circuit 310 of the computing device 140 is programmed to determine an identity of one or more pest in the crop-containing area 110 based on the combined pest detection data and the pest identity data stored in the electronic database 160. Specifically, in some embodiments, the control circuit 310 of the computing device 140 is configured to access, via the network 150, the pest identity data stored on the electronic database 160 and to compare the pest identity data and the combined pest detection data to determine the identity of one or more pests detected in the crop-containing area 110. In other words, after a pest is detected by the UAV 120 in the crop-containing area 110 and pest detection data is transmitted over the network 150 from the UAV 120 to the computing device 140, in some aspects, the control unit 310 of the computing device 140 is configured to compare the pest identity data (e.g., moving videos or digital still images of crop-damaging pests, pest droppings, pest nests, and/or pest carcasses, etc.) stored in the electronic database 160 to the combined pest detection data (e.g., moving videos or digital still images of crop-damaging pests, pest droppings, pest nests, and/or pest carcasses, etc.) that are captured by the visible light video camera 124 and infrared video camera 126 of the UAV 120 in order find a pest in the pest identity data having characteristics that match the characteristics of the pest detected in the crop-containing area 110 by the UAV 120 to thereby identify the pest detected by the UAV 120.

In some embodiments, the control circuit 310 of the computing device 140 is programmed to generate a control signal to the UAV 120 based on a determination of the identity of the pest by the control circuit 310 of the computing device 140. For example, such a control signal may instruct the UAV 120 to move in a way that would scare or herd the identified pest away from the crop-containing area 110, to emit a noise designed to scare the identified pest away from the crop-containing area 110, to release a chemical that would scare or herd the identified pest away from the crop-containing area 110, and/or to release a chemical that would kill the identified pest. In some aspects, the control circuit 310 is programmed to cause the computing device 140 to transmit such control signal to the UAV 120 over the network 150.

The control circuit 310 of the computing device 140 is also electrically coupled via a connection 335 to an input/output 340 (e.g., wireless interface) that can receive wired or wireless signals from one or more UAVs 120. Also, the input/output 340 of the computing device 140 can send signals to the UAV 120, such as signals including instructions indicating an identity of a pest detected by the UAV 120 and/or how to respond to a specific identified pest, or which docking station 130 to land on for recharging while patrolling the crop-containing area 110 along a route predetermined by the computing device 140.

In the embodiment shown in FIG. 3, the processor-based control circuit 310 of the computing device 140 is electrically coupled via a connection 345 to a user interface 350, which may include a visual display or display screen 360 (e.g., LED screen) and/or button input 370 that provide the user interface 350 with the ability to permit an operator of the computing device 140, to manually control the computing device 140 by inputting commands via touch-screen and/or button operation and/or voice commands to, for example, to send a signal to the UAV 120 in order to, for example: control directional movement of the UAV 120 while the UAV 120 is moving along a (flight or ground) route (over or on the crop-containing area 110) predetermined by the computing device 140; control movement of the UAV 120 while the UAV 120 is landing onto a docking station 130; control movement of the UAV 120 while the UAV is lifting off a docking station 130; control movement of the UAV 120 while the UAV 120 is in the process of eliminating one or more pests from the crop-containing area 110; and/or control the response of the UAV 120 to a pest identified in the crop-containing area 110. Notably, the performance of such functions by the processor-based control circuit 310 of the computing device 140 is not dependent on actions of a human operator, and that the control circuit 310 may be programmed to perform such functions without being actively controlled by a human operator.

In some embodiments, the display screen 360 of the computing device 140 is configured to display various graphical interface-based menus, options, and/or alerts that may be transmitted from and/or to the computing device 140 in connection with various aspects of movement of the UAV 120 in the crop-containing area 110 as well as with various aspects of pest detection by the UAV 120 and/or anti-pest response of the UAV 120 based on instructions received by the UAV 120 from the computing device 140. The inputs 370 of the computing device 140 may be configured to permit a human operator to navigate through the on-screen menus on the computing device 140 and make changes and/or updates to the identification of pests detected by the UAV 120, or to the routes and anti-pest outputs of the UAV 120, as well as to the locations of the docking stations 130. It will be appreciated that the display screen 360 may be configured as both a display screen and an input 370 (e.g., a touch-screen that permits an operator to press on the display screen 360 to enter text and/or execute commands.) In some embodiments, the inputs 370 of the user interface 350 of the computing device 140 may permit an operator to, for example, enter an identity of a pest detected in the crop-containing area 110 and to configure instructions to the UAV 120 for responding (e.g., via an output device of the UAV 120) to the identified pest.

In some embodiments, the control circuit 310 of the computing device 140 automatically generates a travel route for the UAV 120 from its deployment station to the crop-containing area 110, and to or from the docking station 130 while moving over or on the crop-containing area 110. In some embodiments, this route is based on a starting location of a UAV 120 (e.g., location of deployment station) and the intended destination of the UAV 120 (e.g., location of the crop-containing area 110, and/or location of docking stations 130 in or around the crop-containing area 110).

The electronic database 160 of FIG. 1 is configured to store pest identity data associated with the crop-damaging pests. For example, in some embodiments, the electronic database 160 stores moving videos or still images of crop-damaging pests, pest droppings, pest nests, crop damage pattern attributable to a specified pest or family of pests, and/or pest carcasses to provide a reference point by the control circuit 310 of the computing device 140 when analyzing the pest detection data captured by the UAV 120 in order to facilitate the identification of pests (detected by the UAV 120) by the control circuit 310 of the computing device 140. The moving videos and/or still images stored in the electronic database 160 may be rendered in visible light format, infrared format, heat signature format, or any other suitable format.

In some embodiments, the electronic database 160 also stores the first pest detection data captured by the visible light video camera 124, second pest detection data captured by the infrared video camera 126, and combined pest detection data generated by the control unit 310 of the computing device 140. In one aspect, each time the control unit 310 of the computing device 140 makes a determination regarding an identity of a pest based on the combined pest detection data and the pest identity data, the electronic database 160 is updated to associate the combined pest detection data with a determined identity of the pest, thereby increasing the pest-identifying reference information stored in the electronic database 160 and expanding the pest-identification capabilities of the control circuit 310 of the computing device 140 when subsequently analyzing new pest detection data captured by the video camera 124 and video camera 126 of the UAV 120.

In some embodiments, the electronic database 160 additionally stores electronic data including but not limited to: data indicating location of the UAV 120 (e.g., GPS coordinates, etc.); data indicating anti-pest output capabilities of the UAV 120 (e.g., to facilitate addition of new module output components providing further ant-pest capabilities; data indicating anti-pest outputs previously deployed by the UAV 120; route of the UAV 120 from a deployment station to the crop-containing area 110; route of the UAV 120 while patrolling the crop-containing area 110; route of the UAV 120 when returning from the crop-containing area 110 to the deployment station; data indicating communication signals and/or messages sent between the computing device 140, UAV 120, electronic database 160, and/or docking station 130; data indicating location (e.g., GPS coordinates, etc.) of the docking station 130; and/or data indicating identity of one or more UAVs 120 docked at each docking station 130.

In some embodiments, location inputs are provided via the network 150 to the computing device 140 to enable the computing device 140 to determine the location of one or more of the UAVs 120 and/or one or more docking stations 130. For example, in some embodiments, the UAV 120 and/or docking station 130 may include a GPS tracking device that permits a GPS-based identification of the location of the UAV 120 and/or docking station 130 by the computing device 140 via the network 150. In one aspect, the computing device 140 is configured to track the location of the UAV 120 and docking station 130, and to determine, via the control circuit 310, an optimal route for the UAV 120 from its deployment station to the crop-containing area 110 and/or an optimal docking station 130 for the UAV 120 to dock to while traveling along its predetermined route. In some embodiments, the control circuit 310 of the computing device 140 is programmed to cause the computing device 140 to communicate such tracking and/or routing data to the electronic database 160 for storage and/or later retrieval.

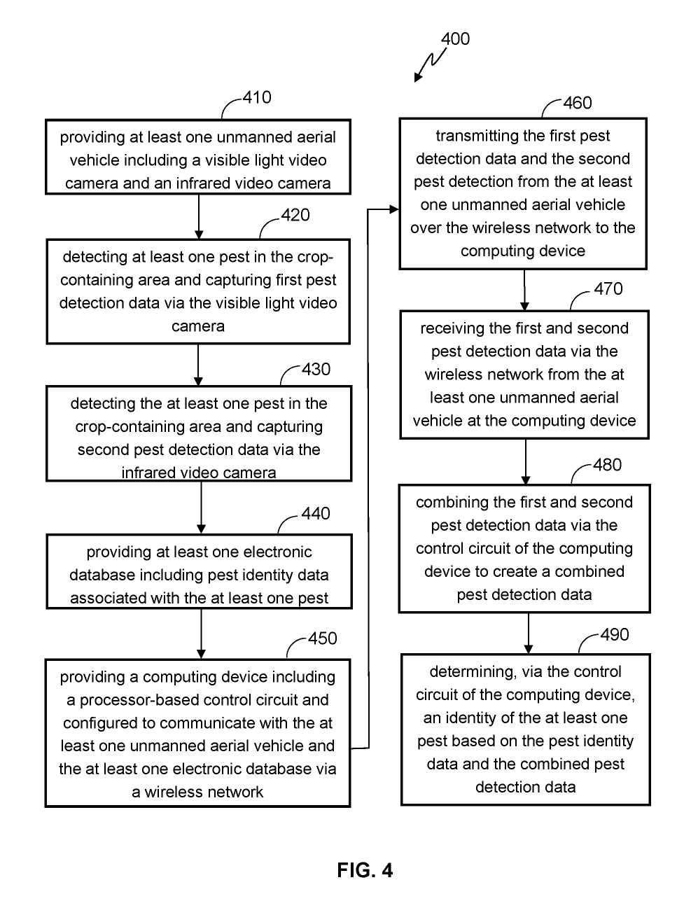

In view of the above description referring to FIGS. 1-3, and with reference to FIG. 4, a method 400 of identifying at least one pest in a crop-containing area 110 according to some embodiments will now be described. While the process 400 is discussed as it applies to identifying one or more pests in a crop-containing area 110 via one or more UAVs 120 shown in FIG. 1, it will be appreciated that the process 400 may be utilized in connection with any of the embodiments described herein.

The exemplary method 400 depicted in FIG. 4 includes providing one or more UAVs 120 including a visible light video camera 124 and an infrared video camera 126 (step 410). The method 400 also includes detecting one or more pests in the crop-containing area 110 and capturing first pest detection data via the visible light video camera 124 (step 420), as well as detecting one or more pests in the crop-containing area 110 and capturing second pest detection data via the infrared video camera 126 (step 430). As discussed above, the pests may be insects, birds, and/or animals capable of damaging the crops in the crop-containing area 110, and the visible light video camera 124 and infrared video camera 126 of the UAV 120 can detect such pests during the day and/or at night and to capture pest detection data associated with such pests. The pest detection data may be a real-time video, still image, infrared image, and/or heat signature of one or more pests, pest droppings, pest carcasses, and/or pest nests.

As discussed above, in some embodiments, one or both of the visible light video camera 124 and infrared video camera 126 are activated by a motion detection-enabled sensor in response to the detection of movement, by the motion sensor, of one or more pests in, or adjacent to, the crop-containing area 110. As discussed above, in some embodiments, docking stations 130 are provided that are configured to provide for recharging of the UAVs 120, replenishment of various components of the UAV 120, and/or addition of modular components configured to change the visual appearance of the UAV 120, or to facilitate better interaction of the UAV 120 with its surrounding environment.

The method 400 of FIG. 4 further includes providing one or more electronic databases 160 including pest identity data associated with one or more crop-damaging pests (step 440) and providing a computing device 140 including a processor-based control circuit 310 and configured to communicate with the UAV 120 and the electronic database 160 via a network 150 (step 450). The computing device 140 was described in detail above and generally combines the first and second pest detection data captured by the visible light video camera 124 and infrared video camera 126, respectively, tracks the locations of the UAV 120 and/or docking station 130, and/or controls the movement of the UAV 120 and/or positioning of the docking stations 130 in the crop-containing area 110 as described above. Similarly, the electronic database 160 was described above and generally stores pest identity data usable by the control circuit 310 of the computing device 140 as a reference point, first pest detection data captured by the visible light video camera 124, second pest detection data captured by the infrared video camera 126, and the combined pest detection data generated by the control unit 310 of the computing device 140.

The method 400 of FIG. 4 further includes transmitting the first pest detection data and the second pest detection from the UAV 120 over the network 150 to the computing device 140 (step 460) and receiving the first and second pest detection data via the network 150 from the UAV 120 at the computing device 140 (step 470). After the first and second pest detection data is received at the computing device 140, the method 400 further includes combining the first and second pest detection data via the control circuit 310 of the computing device 140 to create a combined pest detection data (step 480). In some embodiments, the step of combining the first and second pest detection data of the method 400 includes overlaying, via the control circuit 310 of the computing device 140, the first pest detection data over the second pest detection data to create a combined pest detection data that facilitates a determination, by the control unit 310, of the identity of the pest. In other embodiments, the step of combining the first and second pest detection data of the method 400 includes overlaying, via the control circuit 310 of the computing device 140, the second pest detection data over the first pest detection data to create a combined pest detection data that facilitates a determination, by the control unit 310, of the identity of the pest. As discussed above, since the combined pest detection data includes both reflected visible light data and emitted infrared radiation data, the combined pest detection data advantageously facilitates a more accurate detection and/or identification of pests in the crop-containing area 110 during daylight hours and at night by the control unit 310 of the computing device.

In some embodiments, as discussed above, after generating the combined pest detection data, the control circuit 310 of the computing device 140 causes the computing device 140 to transmit, over the network 150, the combined pest detection data to the electronic database 160 for storage. As such, electronic database 160 can be updated in real time to include up-to-date information relating to the detection of pests in the crop-containing area 110.

After the combined pest detection data is created, the method 400 of FIG. 4 further includes determining, via the control circuit 310 of the computing device 140, an identity of one or more pests based on the pest identity data and the combined pest detection data (step 490). In one aspect, the method 400 includes the control circuit 310 causing the computing device 140 to access, via the network 150, the pest identity data stored on the electronic database 160 and to compare the pest identity data and combined pest detection data generated by the control unit 310 to determine the identity of one or more pests detected in the crop-containing area 110. For example, after a pest is detected by the UAV 120 in the crop-containing area 110 and pest detection data is transmitted over the network 150 from the UAV 120 to the computing device 140, the method 400 may include comparing, via the control circuit 310 of the computing device 140, the moving videos or still images of crop-damaging pests, pest droppings, pest nests, and/or pest carcasses stored in the electronic database 160 to the moving videos or still images of crop-damaging pests, pest droppings, pest nests, and/or pest carcasses that are captured by the visible light video camera 124 and/or infrared video camera 126 in order to identify the pest detected in the crop-containing area by the UAV 120. As such, the pest identity data is stored remotely to the UAV 120 and the determination of the identity of the pest based on the pest detection data is made remotely (at computing device 140) to the UAV 120, thereby advantageously reducing the data storage and processing power requirements of the UAV 120.

After the identity of the pest is determined by the control unit 310 of the computing device 140 as described above, in some embodiments, the method 400 further includes generating and transmitting, via the control circuit 310 of the computing device 140, a control signal to the UAV 120 based on the determination of the identity of the pest by the control circuit 310. For example, the control signal may instruct the UAV 120 to emit a noise specifically designed to scare the identified pest away from the crop-containing area 110, release a chemical specifically designed to kill the identified pest or cause the identified pest away to leave the crop-containing area 110, or to instruct the UAV 120 to move in a way that would scare or herd the identified pest away from the crop-containing area 110.

The systems and methods described herein advantageously provide for semi- automated or fully automated monitoring of crop-containing areas via unmanned vehicles that facilitate detection of one or more pests in the crop-containing area and identification of one or more pests detected in the crop-containing area, which in turn can facilitate the elimination of such pests via the unmanned vehicles from the crop-containing area by way of one or more anti-pest outputs specific to the identified pest. As such, the present systems and methods significantly reduce the resources needed to detect and identify crop-damaging pests in crop-containing areas, thereby not only advantageously facilitating the implementation of more effective anti-pest measures, but also providing significant cost savings to the keepers of the crop-containing areas.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for identifying at least one pest in a crop-containing area, the system comprising:
at least one unmanned aerial vehicle including a visible light video camera configured to detect at least one pest in the crop-containing area and to capture first pest detection data and an infrared video camera configured to detect at least one pest in the crop-containing area and to capture second pest detection data;
at least one electronic database including pest identity data associated with the at least one pest; and
a computing device including a processor-based control circuit and configured to communicate with the at least one unmanned aerial vehicle and the at least one electronic database via a network;
wherein the at least one unmanned aerial vehicle is configured to transmit the first pest detection data and the second pest detection data via the network to the computing device;
wherein, in response to receipt of the first and second pest detection data via the network from the at least one unmanned aerial vehicle, the control circuit of the computing device is configured to combine the first and second pest detection data to create a combined pest detection data; and
wherein the control circuit of the computing device is configured to determine an identity of the at least one pest based on the pest identity data and the combined pest detection data.

2. The system of claim 1, wherein the at least one unmanned aerial vehicle further includes a radar-enabled sensor configured to detect movement of the at least one pest outside of the crop-containing area.

3. The system of claim 1, wherein the at least one unmanned aerial vehicle further includes a motion detection-enabled sensor configured to detect movement of the at least one pest in the crop-containing area.

4. The system of claim 3, wherein the motion detection-enabled sensor is configured to activate at least one of the visible light video camera and the infrared video camera upon detection of movement of the at least one pest in the crop-containing area by the motion detection-enabled sensor.

5. The system of claim 1, wherein the control circuit of the computing device is configured to access, via the network, the pest identity data stored on the at least one electronic database.

6. The system of claim 5, wherein the control circuit of the computing device is configured to compare the pest identity data and the combined pest detection data to determine the identity of the at least one pest.

7. The system of claim 1, wherein the computing device is configured to transmit, over the network, the combined pest detection data to the at least one electronic database, and wherein the at least one electronic database is configured to store the combined pest detection data received from the computing device.

8. The system of claim 1, wherein the control circuit of the computing device is configured to overlay one of the first and second pest detection data over another of the first and second pest detection data to create the combined pest detection data to determine the identity of the at least one pest.

9. The system of claim 1, wherein the control circuit of the computing device is configured to generate a control signal to the at least one unmanned aerial vehicle based on a determination of the identity of the at least one pest by the control circuit of the computing device.

10. The system of claim 9, wherein the computing device is configured to transmit the control signal to the unmanned aerial vehicle over the network.

11. A method of identifying at least one pest in a crop-containing area, the method comprising:
providing at least one unmanned aerial vehicle including a visible light video camera and an infrared video camera;
detecting at least one pest in the crop-containing area and capturing first pest detection data via the visible light video camera;
detecting the at least one pest in the crop-containing area and capturing second pest detection data via the infrared video camera;
providing at least one electronic database including pest identity data associated with the at least one pest;
providing a computing device including a processor-based control circuit and configured to communicate with the at least one unmanned aerial vehicle and the at least one electronic database via a network;
transmitting the first pest detection data and the second pest detection from the at least one unmanned aerial vehicle over the network to the computing device;
receiving the first and second pest detection data via the network from the at least one unmanned aerial vehicle at the computing device;
combining the first and second pest detection data via the control circuit of the computing device to create a combined pest detection data; and
determining, via the control circuit of the computing device, an identity of the at least one pest based on the pest identity data and the combined pest detection data.

12. The method of claim 11, further comprising providing the at least one unmanned aerial vehicle with a radar-enabled sensor configured to detect movement of the at least one pest outside of the crop-containing area.

13. The method of claim 11, further comprising providing the at least one unmanned aerial vehicle with a motion detection-enabled sensor configured to detect movement of the at least one pest in the crop-containing area.

14. The method of claim 13, further comprising detecting movement of the at least one pest in the crop-containing area via the motion detection-enabled sensor and activating, via the motion detection-enabled sensor, at least one of the visible light video camera and the infrared video camera in response to the detecting of the movement of the at least one pest in the crop-containing area via the motion detection-enabled sensor.

15. The method of claim 11, wherein the combining step further comprises accessing, via the control circuit of the computing device and over the network, the pest identity data stored on the at least one electronic database.

16. The method of claim 15, wherein the combining step further comprises comparing, via the control circuit of the computing device, the pest identity data and the combined pest detection data to determine the identity of the at least one pest.

17. The method of claim 11, wherein the combining step further comprises transmitting, from the computing device and over the network, the combined pest detection data to the at least one electronic database, and further comprising storing the combined pest detection data received from the computing device on the at least one electronic database.

18. The method of claim 11, wherein the combining step further comprises overlaying, via the control circuit of the computing device, one of the first and second pest detection data over another of the first and second pest detection data to create the combined pest detection data to determine the identity of the at least one pest.

19. The method of claim 11, further comprising generating, via the control circuit of the computing device, a control signal to the at least one unmanned aerial vehicle based on a determination of the identity of the at least one pest by the control circuit of the computing device.

20. The method of claim 19, wherein the generating step further comprises transmitting the control signal from the computing device to the unmanned aerial vehicle over the network.
